(19) United States
(12) Patent Application Publication
(10) Pub. No.: US 2006/0013313 A1
(43) Pub. Date: Jan. 19, 2006

(54) Scalable video coding method and apparatus using base-layer

(75) Inventors: Woo-jin Han, Suwon-si (KR); Ho-jin Ha, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/181,858

(22) Filed: Jul. 15, 2005

(30) Foreign Application Priority Data
Jul. 15, 2004 (KR) 10-2004-0055269

(51) Int. Cl. H04N 11/02; H04N 11/04; H04B 1/66; H04N 7/12

(52) U.S. Cl. 375/240.21; 375/240.19; 375/240.03

(57) ABSTRACT

A method of more efficiently conducting temporal filtering in a scalable video codec by use of a base-layer is provided. The method of efficiently compressing frames at higher layers by use of a base-layer in a multilayer-based video coding method includes (a) generating a base-layer frame from an input original video sequence, having the same temporal position as a first higher layer frame, (b) upsampling the base-layer frame to have the resolution of a higher layer frame, and (c) removing redundancy of the first higher layer frame on a block basis by referencing a second higher layer frame having a different temporal position from the first higher layer frame and the upsampled base-layer frame.

### CROSS-REFERENCE TO RELATED APPLICATION

This application claims priority from Korean Patent Application No. 10-2004-0055269 filed on Jul. 15, 2004, the disclosure of which is incorporated herein in its entirety by reference.

### BACKGROUND OF THE INVENTION

1. Field of the Invention

Apparatuses and methods consistent with the present invention relate to video compression, and more particularly, conducting temporal filtering more efficiently in a scalable video codec by use of a base-layer.

2. Description of the Related Art

Development of communication technologies such as the Internet has led to an increase in video communication in addition to text and voice communication. However, consumers have not been satisfied with existing text-based communication schemes. To satisfy various consumer needs, multimedia data containing a variety of information including text, images, music and the like has been increasingly provided. Multimedia data is usually voluminous and it requires a large capacity storage medium. Also, a wide bandwidth is required for transmitting the multimedia data. For example, a picture in 24 bit true color having a resolution of 640×480 requires 640×480×24 bits per frame, that is, 7.37 Mbits. In this respect, a bandwidth of approximately 1200 Gbits is needed to transmit this data at 30 frames/second, and a storage space of approximately 1200 Gbits is needed to store a 90 minute movie. Taking this into consideration, it is necessary to use a compressed coding scheme when transmitting multimedia data.

A basic principle of data compression is to eliminate redundancy in the data. The three types of data redundancy are: spatial redundancy, temporal redundancy, and perceptual-visual redundancy. Spatial redundancy refers to the duplication of identical colors or objects in an image, temporal redundancy refers to little or no variation between adjacent frames in a moving picture frame or successive repetition of the same sounds in audio, and perceptual-visual redundancy refers to the limitations of human vision and the inability to hear high frequencies. By eliminating these redundancies, data can be compressed. Data compression types can be divided into loss/lossless compression depending upon whether source data is lost, intra-frame/inter-frame compression depending upon whether data is compressed independently relative to each frame, and symmetrical/asymmetrical compression depending upon whether compression and restoration of data involve the same period of time. In addition, when a total end-to-end delay time in compression and decompression does not exceed 50 ms, this is referred to as real-time compression. When frames have a variety of resolutions, this is referred to as scalable compression. Lossless compression is mainly used in compressing text data or medical data, and loss compression is mainly used in compressing multimedia data. Intra-frame compression is generally used in eliminating spatial redundancy and inter-frame compression is used in eliminating temporal redundancy.

Transmission media to transmit multimedia data have different capacities. Transmission media in current use have a variety of transmission speeds, covering ultra-high-speed communication networks capable of transmitting data at a rate of tens of Mbits per second, mobile communication networks having a transmission speed of 384 kbits per second and so on. In conventional video encoding algorithms, e.g., MPEG-1, MPEG-2, MPEG-4, H.263 and H.264, temporal redundancy is eliminated by motion compensation, and spatial redundancy is eliminated by spatial transformations. These schemes have good performance in compression but they have little flexibility for a true scalable bitstream because main algorithms of the schemes employ recursive approaches.

For this reason, research has been focused recently on wavelet-based scalable video coding. Scalable video coding refers to video coding having scalability in a spatial domain, that is, in terms of resolution. Scalability has a property of enabling a compressed bitstream to be decoded partially, whereby videos having a variety of resolutions can be played.

The term “scalability” herein is used to collectively refer to special scalability available for controlling the resolution of a video, signal-to-noise ratio (SNR) scalability available for controlling the quality of a video, and temporal scalability available for controlling the frame rates of a video, and combinations thereof.

As described above, the spatial scalability may be implemented based on wavelet transformation, and SNR scalability may be implemented based on quantization. Recently, temporal scalability has been implemented using motion compensated temporal filtering (MCTF), and unconstrained motion compensated temporal filtering (UMCTF).

FIGS. 1 and 2 illustrate exemplary embodiments of temporal scalability using a conventional MCTF filter. In particular, FIG. 1 illustrates temporal filtering in an encoder and FIG. 2 illustrates inverse-temporal filtering in a decoder.

In FIG. 2, L frames indicate low-pass or average frames and H frames indicate high-pass or difference frames. As illustrated, in a coding process, frame pairs at the low temporal level are first temporarily filtered, to thereby transform the frames into L frames and H frames at a temporal level higher than the current temporal level, and pairs of the transformed L frames are again temporarily filtered and transformed into frames at a temporal level higher than the current temporal level. Here, the H frame is generated by performing motion estimation by referencing an L frame or an original video frame as a reference frame at a different position and then performing temporal filtering. FIG. 1 represents reference frames referenced by the H frame by means of arrows. As illustrated, the H frame may be referenced bi-directionally, or either backwardly or forwardly.

As a result, an encoder generates a bitstream by use of an L frame at the highest level and remaining H frames, which have passed through a spatial transformation. The darker-colored frames in FIG. 2 indicate that they have been subject to the spatial transformation.

A decoder restores frames by an operation of putting darker-colored frames obtained from a received bitstream (20 or 25 as shown in FIG. 3) through an inverse spatial transformation in order from the highest level to the lowest level. Two L frames at the second temporal level are restored by use of an L frame and an H frame at the third temporal level, and four L frames at the first temporal level are restored by use of two L frames and two H frames at the second temporal level. Finally, eight frames are restored by use of four L frames and four H frames at the first temporal level.

The whole construction of a video coding system supporting scalability, that is, a scalable video coding system, is illustrated in FIG. 3. An encoder 40 encodes an input video 10 through temporal filtering, spatial transformation and quantization, to thereby generate a bitstream 20. A pre-decoder 50 extracts texture data of the bitstream 20 received from the encoder 40, based on extraction conditions such as picture quality, resolution or frame rate considering the communication environment with the decoder 60, or device performance at the decoder 60 side.

The decoder 60 inverses the operations conducted by the encoder 40 and restores an output video 30 from the extracted bitstream 25. Extraction of the bitstream based on the above-described extraction conditions is not limited to the pre-decoder 50; it may be conducted by the decoder 60, or by both the pre-decoder 50 and the decoder 60.

The scalable video coding technology described above is based on MPEG-21 scalable video coding. This coding technology employs temporal filtering such as MCTF and UMCTF to support temporal scalability, and spatial transformation using a wavelet transformation to support spatial scalability.

This scalable video coding is advantageous in that quality, resolution and frame rate can all be transmitted at the pre-decoder 50 stage, and the compression rate is excellent. However, where the bitrate is not sufficient, the performance may deteriorate, compared to conventional coding methods such as MPEG-4, H.264 and the like.

There are mixed causes for this. Performance of the wavelet transformation degrades at low resolutions, as compared to the discrete cosine transform (DCT). Because of inherent properties of scalable video coding to support multiple bitrates, optimal performance occurs at one bitrate, and for this reason, the performance degrades at other bitrates.

### SUMMARY OF THE INVENTION

The present invention provides a scalable video coding method demonstrating even performance both at a lower rate and a higher bitrate.

The present invention also provides a method of performing compression based on a coding method showing high performance at a low rate, at the lowest bitrates among the bitrates to be supported, and performing wavelet-based scalable video coding using the result at the other bitrates.

The present invention also provides a method of performing motion estimation using the result coded at the lowest bitrate at the time of the wavelet-based scalable video coding.

According to an aspect of the present invention, there is provided a method of efficiently compressing frames at higher layers by use of a base-layer in a multilayer-based video coding method, comprising (a) generating a base-layer frame from an input original video sequence, having the same temporal position as a first higher layer frame, (b) upsampling the base-layer frame to have the resolution of a higher layer frame, and (c) removing redundancy of the first higher layer frame on a block basis by referencing a second higher layer frame having a different temporal position from the first higher layer frame and the upsampled base-layer frame.

According to another aspect of the present invention, there is provided a video encoding method comprising (a) generating a base-layer from an input original video sequence, (b) upsampling the base-layer to have the resolution of a current frame, (c) performing temporal filtering of each block constituting the current frame by selecting any one of temporal prediction and prediction using the upsampled base-layer, (d) spatially transforming the frame generated by the temporal filtering, and (e) quantizing a transform coefficient generated by the spatial transformation.

According to another aspect of the present invention, there is provided a method of restoring a temporally filtered frame with a video decoder, comprising (a) obtaining a sum of a low-pass frame and a base-layer, where the filtered frame is the low-pass frame, (b) restoring a high-pass frame on a block basis according to mode information transmitted from the encoder side, where the filtered frame is a high-pass frame, and (c) restoring the filtered frame by use of a temporally referenced frame where the filtered frame is of another temporal level other than the highest temporal level.

According to another aspect of the present invention, there is provided a video decoding method comprising (a) decoding an input base-layer using a predetermined codec, (b) upsampling the resolution of the decoded base-layer, (c) inversely quantizing texture information of layers other than the base-layer, and outputting a transform coefficient; (d) inversely transforming the transform coefficient in a spatial domain, and (e) restoring the original frame from a frame generated as the result of the inverse-transformation, using the upsampled base-layer.

According to another aspect of the present invention, there is provided a video encoder comprising (a) a base-layer generation module to generate a base-layer from an input original video source, (b) a spatial upsampling module upsampling the base-layer to the resolution of a current frame, (c) a temporal filtering module to select any one of temporal estimation and estimation using the upsampled base-layer, and temporally filtering each block of the frame, (d) a spatial transformation module to spatially transform the frame generated by the temporal filtering, and (e) a quantization module to quantize a transform coefficient generated by the spatial transform.

According to another aspect of the present invention, there is provided a video decoder comprising (a) a base-layer decoder to decode an input base-layer using a predetermined codec, (b) a spatial upsampling module to upsample the resolution of the decoded base-layer, (c) an inverse quantization module to inversely quantize texture information about layers other than the base-layer, and to output a transform coefficient, (d) an inverse spatial transform module to inversely transform the transform coefficient into a spatial domain, and (e) an inverse temporal filtering module to restore the original frame from a frame generated as the result of inverse transformation, by use of the upsampled base-layer.

### BRIEF DESCRIPTION OF THE DRAWINGS

The above and other aspects of the present invention will become more apparent by describing in detail exemplary embodiments thereof with reference to the attached drawings in which:

FIG. 1 illustrates a conventional MCTF filtering at an encoder side;

FIG. 2 illustrates a conventional MCTF inverse filtering at a decoder side;

FIG. 3 illustrates a whole construction of a conventional scalable video coding system;

FIG. 4 illustrates a construction of a scalable video encoder according to an exemplary embodiment of the present invention;

FIG. 5 illustrates temporal filtering according an exemplary embodiment of the present invention;

FIG. 6 diagrams the modes according to an exemplary embodiment of the present invention;

FIG. 7 illustrates an example that a high-pass frame present at the highest temporal level is encoded in different modes by each block according to a cost function;

FIG. 8 illustrates an example that an input image is decomposed into sub-bands by wavelet transformation;

FIG. 9 illustrates a schematic construction of a bitstream according to an exemplary embodiment of the present invention;

FIG. 10 illustrates a schematic construction of bitstreams at other layer;

FIG. 11 illustrates a detailed structure of a GOP field;

FIG. 12 illustrates an example that an encoder is embodied in an in-band mode, according to an exemplary embodiment of the present invention;

FIG. 13 illustrates a construction of a scalable video decoder according to an exemplary embodiment of the present invention; and

FIG. 14 is a graph representing PSNR to a bitrate in a mobile sequence.

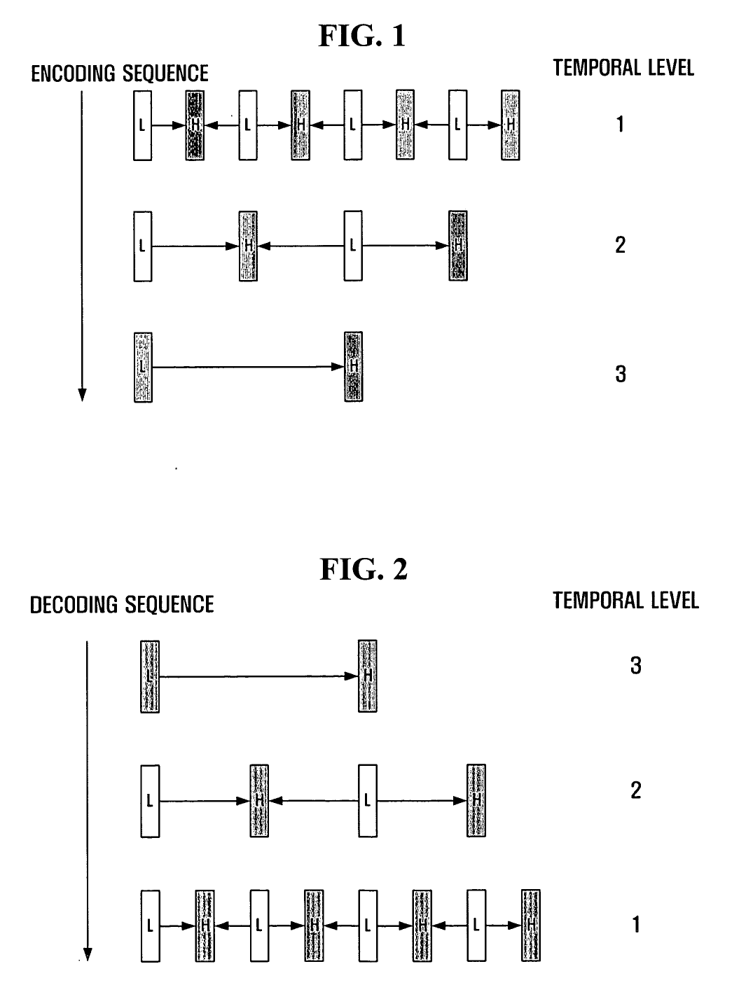

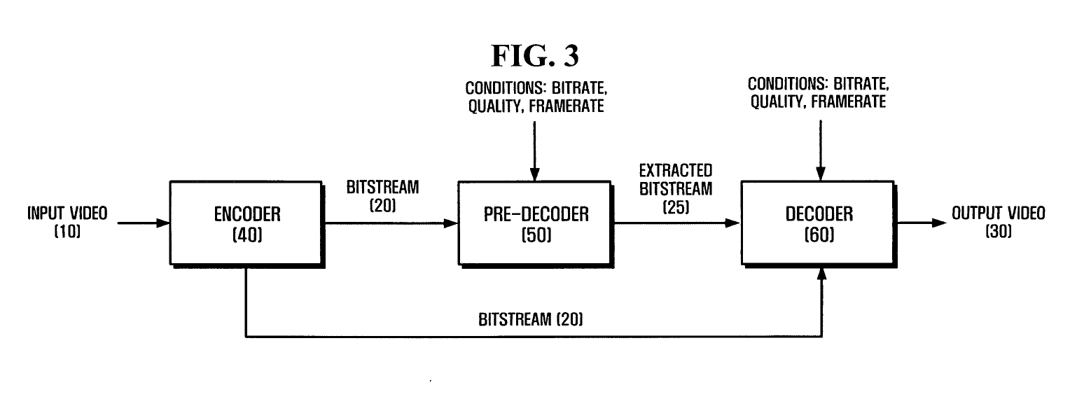

### DETAILED DESCRIPTION OF EXEMPLARY EMBODIMENTS

Hereinafter, exemplary embodiments of the present invention will be described in detail with reference to the accompanying drawings. Advantages and features of the present invention and methods of accomplishing the same may be understood more readily by reference to the following detailed description of exemplary embodiments to be described in detail and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

In an exemplary embodiment of the present invention, compression of a base-layer is performed according to a coding method having a high performance at low bitrates, such as MPEG-4 or H.264. By applying wavelet-based scalable video coding so as to support scalability at bitrates higher than the base-layer, the advantages of wavelet-based scalable video coding are retained and performance at low bitrates is improved.

Here, the term “base-layer” refers to a frame-rate lower than the highest frame-rate of a bitstream generated by a scalable video encoder, or a video sequence having a resolution lower than the highest resolution of the bitstream. The base-layer may have any frame-rate and resolution other than the highest frame-rate and resolution. Although the base-layer does not need to have the low frame-rate and resolution of the bitstream, the base-layer according to exemplary embodiments of the present invention will be described by way of example as having the lowest frame-rate and resolution.

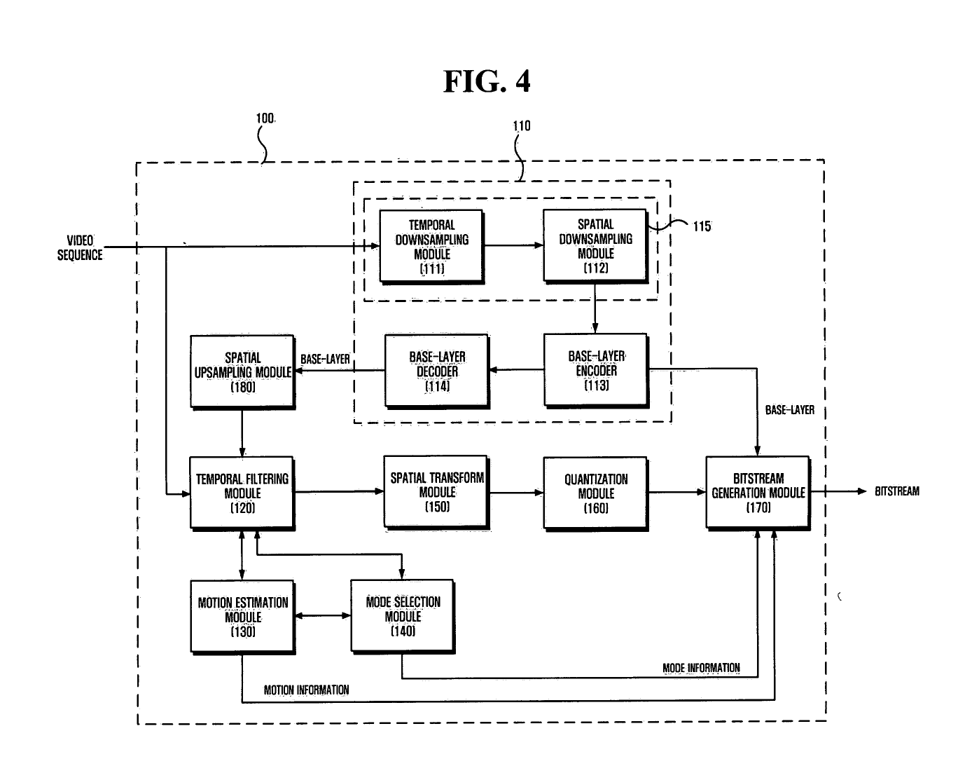

In this specification, the lowest frame-rate and resolution, or the highest resolution (to be described later) are all determined based on the bitstream, which is different from the lowest frame-rate and resolution or the highest resolution inherently supported by a scalable video encoder. The video scalable encoder 100 according to an exemplary embodiment of the present invention is illustrated in FIG. 4. The scalable video encoder 100 may comprise a base-layer generation module 110, a temporal filtering module 120, a motion estimation module 130, a mode selection module 140, a spatial transform module 150, a quantization module 160, a bitstream generation module 170, and a spatial upsampling module 180. The base-layer generation module 110 may comprise a temporal downsampling module 111, a spatial downsampling module 112, a base-layer encoder 113 and a base-layer decoder 114. The temporal downsampling module 111 and the spatial downsampling module 112 may be incorporated into a single downsampling module 115.

An input video sequence is inputted to the base-layer generation module 110 and the temporal filtering module 120. The base-layer generation module 110 transforms the input video sequence, that is, the original video sequence having the highest resolution and frame-rate into a video sequence having the lowest frame-rate supported by the temporal filtering and the lowest resolution supported by the temporal transformation.

Then, the video sequence is compressed by a codec that produces excellent quality at low bitrates, and is then restored. This restored image is defined as a “base-layer.” By upsampling this base-layer, a frame having the highest resolution is again generated and supplied to the temporal filtering module 120 so that it can be used as a reference frame in a B-intra estimation.

Operations of specific modules constituting the base-layer generation module 110 will now be described in more detail.

The temporal downsampling module 111 downsamples the original video sequence having the highest frame-rate into a video sequence having the lowest frame-rate supported by the encoder 100. This temporal downsampling may be performed by conventional methods; for example, simply skipping a frame, or skipping a frame and at the same time partly reflecting information of the skipped frame on the remaining frames. Alternatively, a scalable filtering method supporting temporal decomposition, such as MCTF, may be used.

The spatial downsampling module 112 downsamples the original video sequence having the highest resolution into a video sequence having the lowest resolution. This spatial downsampling may also be performed by conventional methods. This is a process to reduce a multiplicity of pixels to a single pixel, and thus, predetermined operations are conducted on the multiplicity of pixels to produce a single pixel. Various operations such as mean, median, and DCT downsampling may be involved. A frame having the lowest resolution may be extracted through a wavelet transformation. In exemplary embodiments of the present invention, it is preferable that the video sequence be downsampled through the wavelet transformation. Exemplary embodiments of the present invention require both downsampling and upsampling in the temporal domain. The wavelet transformation is relatively well-balanced in downsampling and upsampling, as compared to other methods, thereby producing a better quality.

The base-layer encoder 113 encodes a video sequence having the lowest temporal and spatial resolutions by use of a codec producing excellent quality at low bitrates. Here, the term “excellent quality” implies that the video sequence is less distorted than the original when it is compressed at the same bitrate and then restored. Peak signal-to-noise ratio (PSNR) is mainly used as a standard for determining the quality.

It may be preferable that a codec of the non-wavelet family, such as H.264 or MPEG-4 is used. The base-layer encoded by the base-layer encoder 113 is supplied to the bitstream generation module 170.

The base-layer decoder 114 decodes the encoded base-layer by use of a codec corresponding to the base-layer encoder 113 and restores the base-layer. The reason a decoding process is performed again after the encoding process is to restore a more precise image by making it identical to a process of restoring the original video from the reference frame. However, the base-layer decoder 114 is not essential. The base-layer generated by the base-layer encoder 113 can be supplied to the spatial upsampling module 180 as is.

The spatial upsampling module 180 upsamples a frame having the lowest frame-rate, thereby producing the highest resolution. However, since wavelet decomposition was used by the spatial downsampling module 112, it is preferable that a wavelet-based upsampling filter be used.

The temporal filtering module 120 decomposes frames into low-pass frames and high-pass frames along a time axis in order to decrease temporal redundancy. In exemplary embodiments of the present invention, the temporal filtering module 120 performs not only temporal filtering but also difference filtering by the B-intra mode. Thus, “temporal filtering” includes both temporal filtering and filtering by the B-intra mode.

The low-pass frame refers to a frame encoded not referencing any other frame, and the high-pass frame refers to a frame generated by a difference between a predicted frame (through motion estimation) and a reference frame. Various methods may be involved in determining a reference frame. A frame inside or outside a group of pictures (GOP) may be used as a reference frame. However, since the bit number of a motion vector may increase as the reference frame increases, two frames adjacent to each other may be both used as reference frames, or only one of them may be used as a reference frame. In this respect, exemplary embodiments of the present invention will be described under the assumption that at maximum two adjacent frames may be referenced, but the present invention is not limited thereto.

Motion estimation based on a reference frame is performed by the motion estimation module 130, and the temporal filtering module 120 may control the motion estimation module 130 to perform the motion estimation and have the result returned to it whenever required.

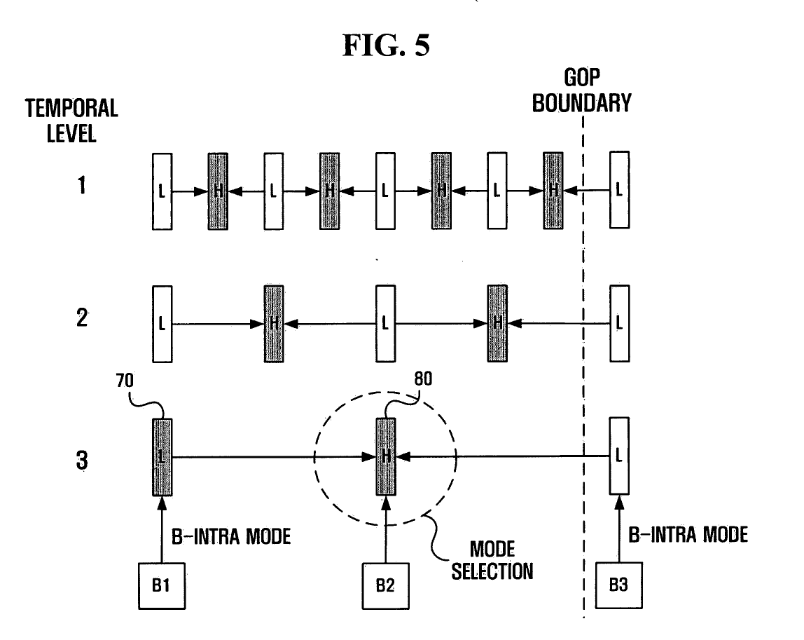

MCTF and UMCTF may be used to perform temporal filtering. FIG. 5 illustrates an operation of exemplary embodiments of the present invention using MCTF (5/3 filter). A GOP consists of eight frames, which may be referenced out of the GOP boundary. First, eight frames are decomposed into four low-pass frames (L) and four high-pass frames (H) at the first temporal level. The high-pass frames may be generated by referencing both a left frame and a right frame, or any one of the left frame and the right frame. Thereafter, the low-pass frames may update themselves again using left and right high-pass frames. This updating does not use the low-pass frames as the original frames, but updates them by using the high-pass frames, thereby serving to disperse errors concentrated in the high-pass frames. However, this updating is not essential. Hereinafter, updating will be omitted, and an example where the original frames become low-pass frames will be described.

Next, four low-pass frames at the first temporal level are again decomposed into two low-pass frames and two high-pass frames at the second temporal level. Last, two low-pass frames at the second temporal level are decomposed into one low-pass frame and one high-pass frame at the third temporal level. Thereafter, one low-pass frame and the other seven high-pass frames at the higher temporal levels are encoded and then transmitted.

Frames at the highest temporal level, that is, frames having the lowest frame-rate, are filtered using a different method than the conventional temporal filtering method. Accordingly, the low-pass frame 70 and the high-pass frame 80 are filtered at the third temporal level within the current GOP by a method proposed by the present invention.

The base-layer upsampled with the highest resolution by the base-layer generation module 110 is already at the lowest frame-rate. It is supplied by as many as the respective numbers of the low-pass frames 70 and the high-pass frames 80.

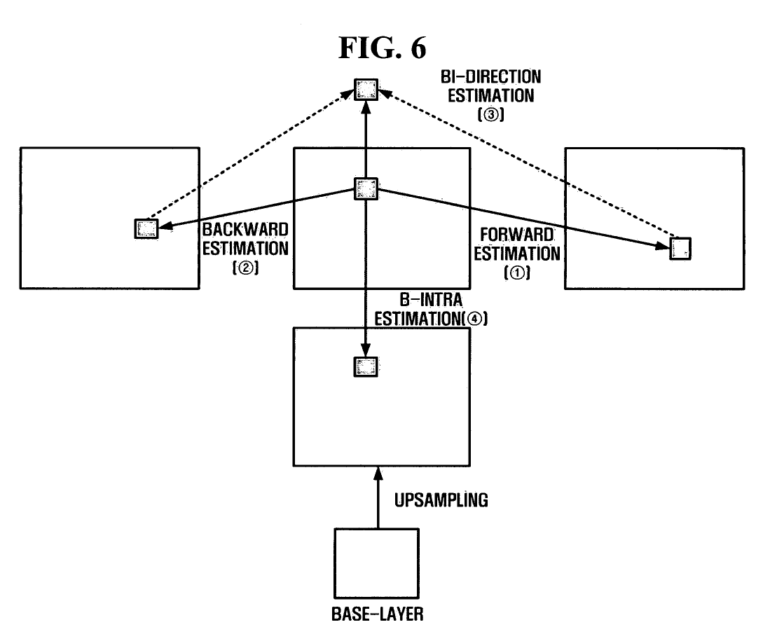

The low-pass frame 70 has no reference frame in the temporal direction, and thus, it is coded in the B-intra mode by obtaining the difference between the low-pass frame 70 and the upsampled base-layer B1. Since the high-pass frame 80 may reference both left and right low-pass frames in the temporal direction, it is determined by the mode selection module 140 according to a predetermined mode selection on a block basis whether the temporally-related frame or the base-layer will be used as a reference frame. Then, it is coded according to methods determined on a block basis by the temporal filtering module 120. Mode selection by the mode selection module 140 will be described with reference to FIG. 6. In this specification, a “block” may refer to a macro-block or a sub-block having the partitioned size from the macro block.

In the previous example the highest temporal level was 3 and the GOP had eight frames. However, exemplary embodiments of the present invention can have any number of temporal levels and any GOP size. For example, when the GOP has eight frames and the highest temporal level is 2, among the four frames present at the second temporal level, two L frames perform a difference coding and two H frames perform a coding according to a mode selection. Further, it has been described that only one of left and right adjacent frames is referenced (as in FIG. 5) to determine a reference frame in the temporal direction. However, it is obvious to those in the art that exemplary embodiments of the present application may be applied where left and right frames not adjacent may be referenced in plural.

The mode selection module 140 selects a reference frame between a temporally relevant frame and a base-layer, on a block basis, by using a predetermined cost function with respect to the high-pass frame at the highest temporal level mode selection. FIG. 4 illustrates the mode selection module 140 and the temporal filtering module 120 as separate elements, but the mode selection module 140 may be incorporated into the temporal filtering module 120.

Rate-distortion (R-D) optimization may be used in mode selection. This method will be described more specifically with reference to FIG. 6.

FIG. 6 illustrates four exemplary modes. In a forward estimation mode (1), a specific block in the current frame that best matches part of the former frame (which does not refer to the immediately former frame) is searched and a motion vector for displacement between two positions is obtained, thereby obtaining the temporal residual.

In a backward estimation mode (2), a specific block in the current frame that best matches part of the next frame (which does not refer to the immediately after frame) is searched and a motion vector for displacement between two positions is obtained, thereby obtaining the temporal residual.

In a bi-directional estimation mode (3), the two blocks searched in the forward estimation mode (1) and the backward estimation mode (2) are averaged, or are averaged with a weight, so as to create a virtual block, and the difference between the virtual block and the specific block in the current frame is computed, thereby performing temporal filtering. Accordingly, the bi-directional estimation mode needs two motion vectors for each block. These forward, backward and bi-directional estimations are all in the category of temporal estimation. The mode selection module 140 uses the motion estimation module 130 to obtain the motion vectors.

In the B-intra mode (4), the base-layer upsampled by the spatial upsampling module 180 is used as the reference frame, and a difference from the current frame is computed. In this case, the base-layer is a frame temporally identical to the current frame, and thus, it needs no motion estimation. In the present invention, the term “difference” is used in the B-intra mode so as to distinguish it from the term “residual” between frames in the temporal direction.

In FIG. 6, an error (mean absolute difference or MAD) caused in selecting a backward estimation mode is referred to as “Eb,” an error caused in selecting a forward estimation mode is referred to as “Ef,” an error caused in selecting a bi-directional estimation mode is referred to as “Ebi,” and an error caused in using a base-layer as a reference frame is referred to as Ei, and additional bits consumed by each are respectively referred to as Bb, Bf, Bbi, and Bi. In connection with this, each cost function is defined below, where Bb, Bf, Bbi, and Bi imply the bits consumed in compressing motion information including motion vector and motion frame in each direction. However, since the B-intra mode uses no motion vector, Bi is very small and may be deleted.
Backward Cost: Cb=Eb+λ×Bb
Forward Cost: Cf=Ef+λ×Bf
Bi-directional Cost: Cbi=Ebi+λ×Bbi=Ebi+λ×(Bb+Bf)
B-intra Cost: Ci=α(Ei+λ×Bi)≈α×Ei,
   where λ is a Lagrangian coefficient, a constant value determined according to the rate of compression. The mode selection module 140 uses these functions to select a mode having the lowest cost, thereby allowing the most appropriate mode for the high-pass frame at the highest temporal level to be selected.

Unlike the other costs, another constant, α, is added to the B-intra cost. α is a constant to indicate a weight of the B-intra mode. If α is 1, the B-intra mode is selected equally through a comparison with other cost functions. As a increases, B-intra mode is selected less often, and as a decreases, B-intra mode is more often selected. As an extreme example, if a is 0, only the B-intra mode is selected; no B-intra mode is selected if α is too high. The user may control the frequency of B-intra mode selection by controlling the value of α.

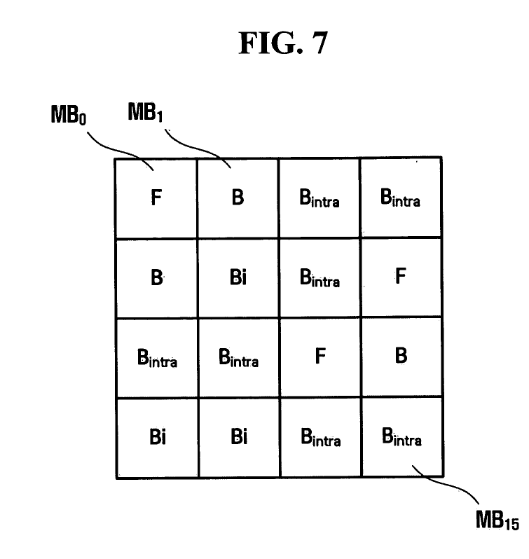

FIG. 7 illustrates an example that high-pass frames present in the highest temporal level are encoded in different modes on a block basis according to the cost function. Here, a frame consists of 16 blocks, and “MB” represents each block. F, B, Bi and Bintra indicate that filtering is conducted in the forward estimation mode, the backward estimation mode, the bi-directional estimation mode, and the B-intra estimation mode, respectively.

In FIG. 7, a block MBo is filtered in the forward estimation mode because Cf is the lowest value of Cb, Cf, Cbi and Ci, and a block MB₁₅ is filtered in the B-intra mode because Ci is the lowest value. Last, the mode selection module 140 supplies information about the mode selected through the above processes to the bitstream generation module 170.

Referring to FIG. 4, the motion estimation module 130 is called by the temporal filtering module 120 or the mode selection module 140, and performs motion estimation of the current frame based on the reference frame determined by the temporal filtering module 120, to thereby obtain a motion vector. That is, a displacement where an error reaches the lowest value while moving a given block at the pixel (or sub-pixel) accuracy within a specific searching area of a reference frame is estimated as a motion vector. For motion estimation, a fixed block may be used as in FIG. 7, but a hierarchical method such as hierarchical variable size block matching (HVSBM) may also be used. The motion estimation module 130 provides a motion vector obtained as a result of motion estimation, and motion information including reference frame numbers to the bitstream generation module 170.

The spatial transform module 150 removes spatial redundancy from a frame whose temporal redundancy has been removed by the temporal filtering module 120 by use of a spatial transformation supporting spatial scalability such as Wavelet transformation. Coefficients obtained as a result of the spatial transformation are called transform coefficients.

To describe an example of using wavelet transformation in detail, the spatial transform module 150 decomposes a frame whose temporal redundancy has been removed into a low-pass sub-band and a high-pass sub-band through wavelet transformation, and obtains wavelet coefficients for each of them.

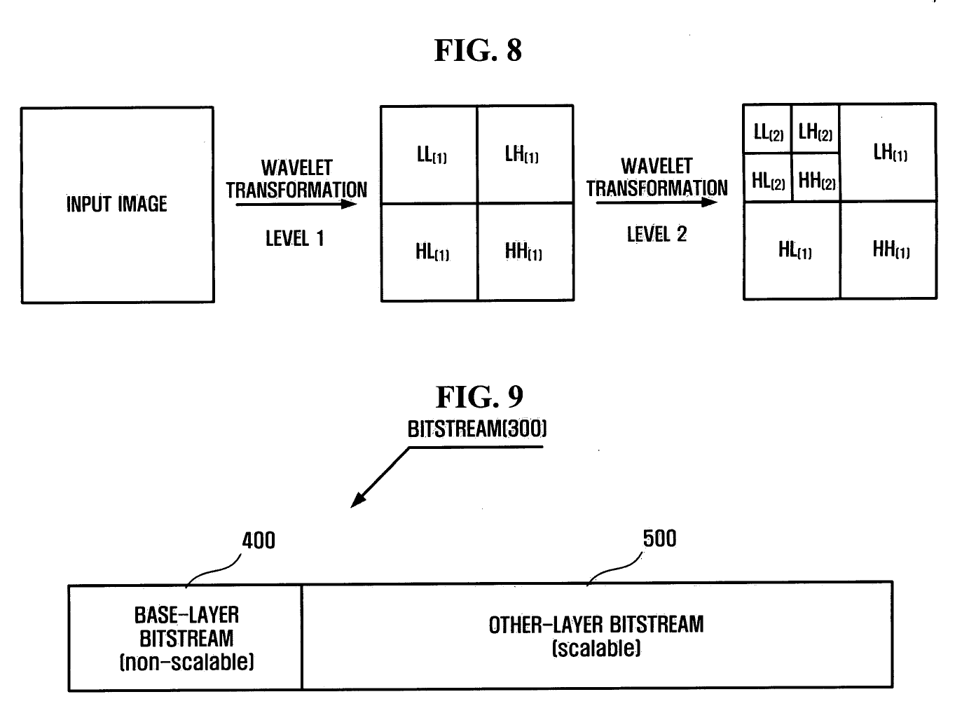

FIG. 8 illustrates an example of decomposing an input video or frame into sub-bands by wavelet transformation, which is separated into two levels. There are three high-pass sub-bands: horizontal, vertical and diagonal. “LH” refers to a horizontal high-pass sub-band, “HL” to a vertical high-pass sub-band, and “HH” to a horizontal and vertical high-pass sub-band. And, “LL” refers to a horizontal and vertical low-pass sub-band. The low-pass sub-band may be decomposed repeatedly. The numerals in the bracket indicate the levels of wavelet transformation.

The quantization module 160 quantizes a transform coefficient obtained by the spatial transform module 150. The term “quantization” indicates a process to divide the transform coefficients and take integer parts from the divided transform coefficients, and match the integer parts with predetermined indices. When wavelet transformation is used as a spatial transformation method, an embedded quantization is mainly used as a quantization method. This embedded quantization includes an embedded zero-trees wavelet (EZW) algorithm, a set partitioning in hierarchical trees (SPIHT) algorithm, and an embedded zero-block coding (EZBC) algorithm.

The bitstream generation module 170 encodes base-layer data encoded by the base-layer encoder 1130, a transform coefficient quantized by the quantization module 160, mode information supplied by the mode selection module 140, and motion information supplied by the motion estimation module 130 without loss, and generates a bitstream. This lossless encoding includes arithmetic coding, and various entropy coding methods such as variable length coding.

FIG. 9 illustrates a schematic construction of a bitstream 300 according to an exemplary embodiment of the present invention. The bitstream 300 may consist of a base-layer bitstream 400 losslessly encoding the encoded base-layer, and a bitstream supporting spatial scalability and losslessly encoding the transform coefficient transmitted from the quantization module 160, that is, an other-layer bitstream 500.

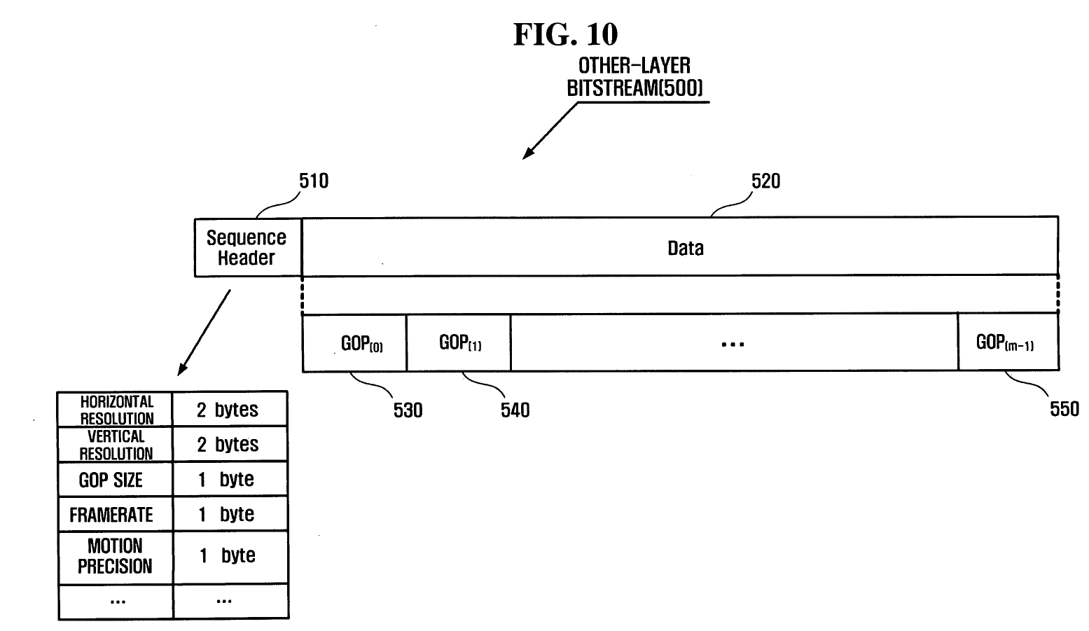

As illustrated in FIG. 10, the other-layer bitstream 500 consists of a sequence header field 510 and a data field 520; the data field consists of one or more GOP fields 530, 540 and 550, and the sequence header field 510 records properties of a video such as the width (two bytes) and length (two bytes) of a frame, the size of a GOP (one byte), and a frame rate (one byte). The data field 520 records video data and other information required for restoring videos (e.g., motion information and mode information).

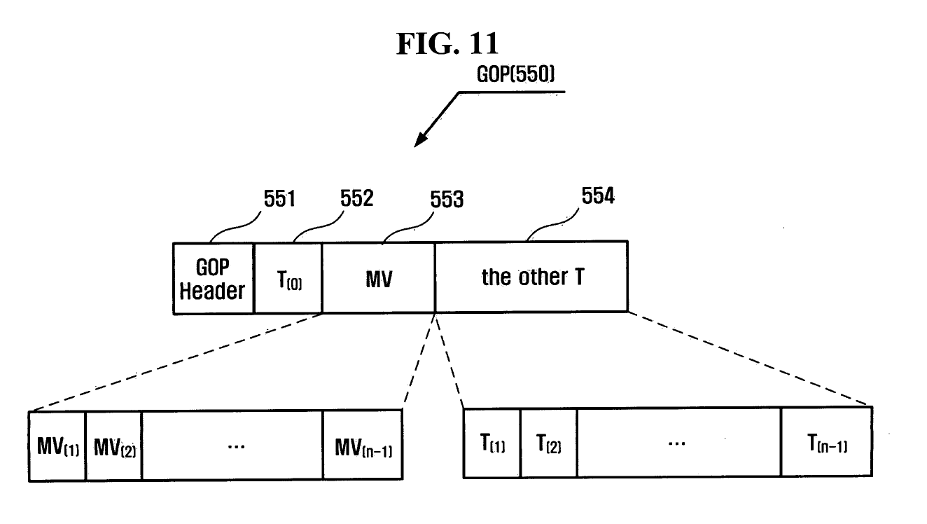

FIG. 11 illustrates detailed structures of respective GOP fields 510, 520 and 550. The GOP fields 510, 520 and 550 each comprise a GOP header 551, a T₍₀₎ field 552 recording therein a frame encoded according to the B-intra mode, an MV field 553 recording motion and mode information therein, and a “the other T” field 554 recording information of a frame encoded by referencing another frame. Motion information includes the size of a block, motion vectors for each block, and a number of reference frames referenced to obtain a motion vector. Mode information is recorded in the form of an index, to indicate in which mode, among forward, backward, bi-directional estimation, and B-intra modes a high-pass frame present in the highest temporal level is encoded. In this exemplary embodiment, it has been described that mode information is recorded in the MV field 553 together with a motion vector, but the present invention is not limited thereto; it can be recorded in a separate mode information field. The MV field 553 is subdivided into MV₍₁₎ to MV₍ₙ₋₁₎ fields by each frame. The other T field 554 is subdivided into T₍₁₎ to T₍ₙ₋₁₎ in which an image of each frame is recorded. Here, ‘n’ refers to the size of the GOP.

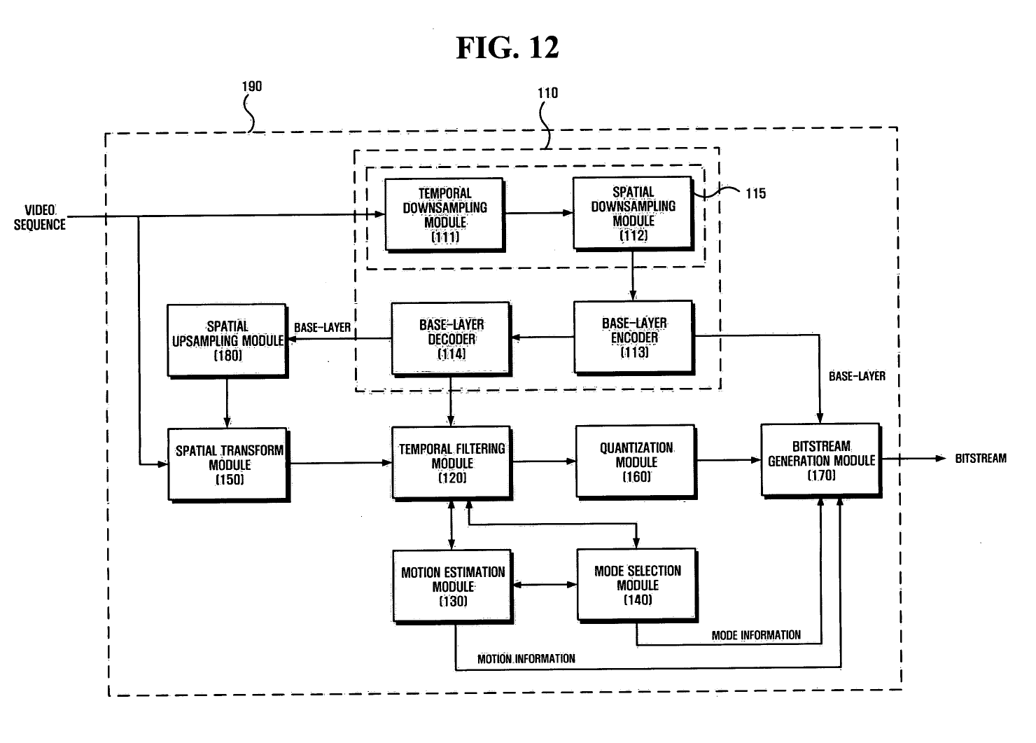

It has been described that spatial transformation is conducted after temporal filtering has been conducted in the encoder 100, but a method of conducting the temporal filtering after spatial transformation, that is, an in-band mechanism, may also be used. FIG. 12 illustrates an example of the encoder 190 according to an exemplary embodiment of the present invention that uses the in-band mechanism. A skilled person in the art will have no difficulty working the present invention because only the sequence of conducting the temporal filtering and the spatial filtering is changed in the in-band encoder 190. To restore the original image from the bitstream encoded by the in-band mechanism, the decoder also has to conduct inverse-spatial transformation after conducting inverse-temporal filtering, in the in-band mechanism.

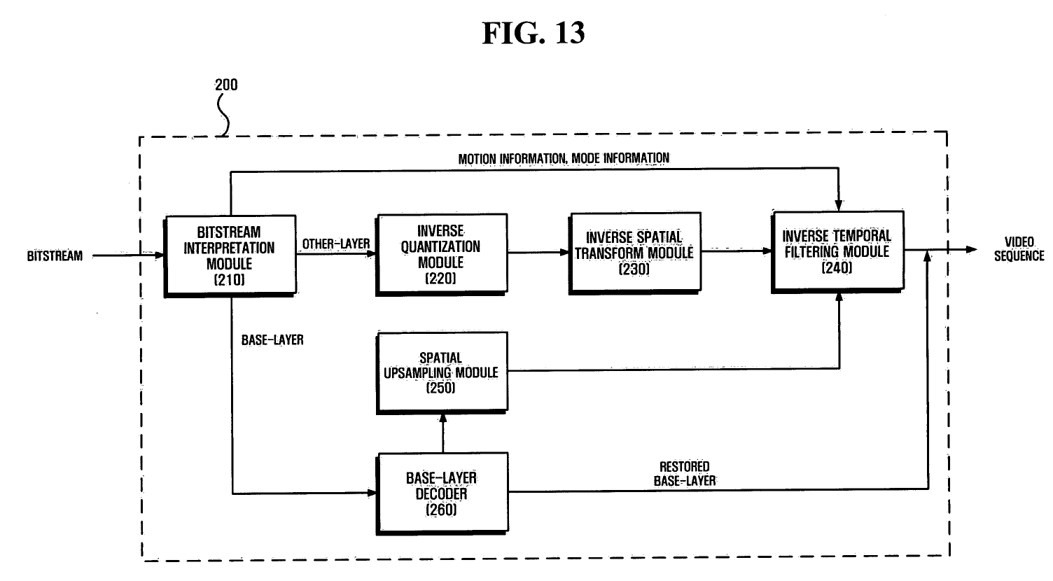

FIG. 13 illustrates a construction of a scalable video decoder 200 according to an exemplary embodiment of the present invention. The scalable video decoder 200 comprises a bitstream interpretation module 210, an inverse-quantization module 220, an inverse-spatial transform module 230, an inverse-temporal filtering module 240, a spatial upsampling module 250 and a base-layer decoder 260.

The bitstream interpretation module 210 interprets an input bitstream (such as bitstream 300) and divides and extracts information on a base-layer and other layers, that is, the inverse to entropy encoding. The base-layer information is supplied to the base-layer decoder 260. Of the other layer information, texture information is supplied to the inverse-quantization module 220 and motion and mode information is supplied to the inverse-temporal filtering module 240.

The base-layer decoder 260 decodes information about the base-layer supplied from the bitsteam interpretation module 210 with the use of a predetermined codec corresponding to the codec used for encoding. That is, the base-layer decoder 260 uses the same module as the base-layer decoder 114 of the scalable video encoder 100 of FIG. 4.

The spatial upsampling module 250 upsamples a frame of the base-layer decoded by the base-layer decoder 260 to the highest resolution. The spatial upsampling module 250 corresponds to the spatial downsampling module 112 of the encoder 100 of FIG. 4, and it upsamples the frame of the lowest resolution to have the highest resolution. If wavelet decomposition is used in the spatial downsampling module 112, it is preferable to use a wavelet-based upsampling filter.

By the way, the inverse-quantization module 220 inversely quantizes texture information supplied by the bitstream interpretation module 210 and outputs a transform coefficient. The inverse-quantization refers to a process of searching for a quantized coefficient matching with a value represented in a predetermined index and then transmitting it. A table mapping indices and quantization coefficients may be transmitted from the encoder 100, or it may be agreed on in advance by the encoder and the decoder.

The inverse spatial transformation module 230 conducts the inverse spatial transformation to inversely transform the transform coefficients into transform coefficients in the spatial domain. For example, when the spatial transformation is conducted in the wavelet mode, the transform coefficients in the wavelet domain are inversely transformed into the transform coefficients in the spatial domain.

The inverse-temporal filtering module 240 inverse-temporally filters a transform coefficient in the spatial domain, that is, a difference image, and restores the frames constituting a video sequence. For inverse-temporal filtering, the inverse-temporal filtering module 240 uses the motion vector and motion information supplied by the bitstream interpretation module 210, and the upsampled base-layer supplied by the spatial upsampling module 250.

The inverse-temporal filtering in the decoder 200 is the inverse of the temporal filtering in the encoder 100 of FIG. 4. That is, the inverse temporal filtering sequence is the inverse of the sequence in the example of FIG. 5. Thus, inverse filtering should be conducted with respect to low-pass frames and high-pass frames at the highest temporal level. For example, as in the case of FIG. 5, the low-pass frame 70 is coded in the B-intra mode, and thus, the inverse-temporal filtering module 240 restores the original image by combining the low-pass frame 70 and the upsampled base-layer supplied by the spatial upsampling module 250. And, the inverse-temporal filtering module 240 inversely filters the high-pass frame 80 according to a mode indicated by the mode information on a block basis. If the mode information of a block represents the B-intra mode, the inverse-temporal filtering module 240 adds the block and an area of the base-layer frame corresponding to the block, thereby restoring a concerned area of the original frame. If mode information of a block represents any other modes than the B-intra mode, the inverse-temporal filtering module 240 can restore a concerned area of the original frame by use of the motion information (number of the reference frame and motion vector) according to estimation direction.

The whole area corresponding to each block is restored by the inverse-temporal filtering module 240, thereby forming a restored frame, and a video sequence is as a whole formed by assembling these frames. It has been described that a bitstream transmitted to the decoder side includes information about a base-layer and the other layers together. However, when only a truncated base-layer from a pre-decoder side, which has received a bitstream transmitted from the encoder 100, is transmitted to the decoder 200, information on the base-layer is only present in the bitstream input to the decoder side. Thus, the base-layer frames restored after having passed through the bitstream interpretation module 210 and the base-layer encoder 260 will be output as a video sequence.

The term ‘module’, as used herein, means, but is not limited to, a software or hardware component, such as a Field Programmable Gate Array (FPGA) or an Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, components and modules may be realized so as to execute one or more computers within a communication system.

According to exemplary embodiments of the present invention, the same performance as that of a codec used in encoding a base-layer can be obtained at the lowest bitrate and the lowest frame-rate. Since a difference image at a higher resolution and frame-rate is efficiently coded by the scalable coding method, better quality than the conventional method is achieved at the lower bitrate, and similar performance to the conventional scalable video coding method is achieved at higher bitrates.

Not selecting any favorable one between a temporal difference and a difference from the base-layer as in exemplary embodiments of the present invention but simply using a difference coding from the base-layer, excellent quality may be obtained at the low bitrate, but it will suffer greatly degraded performance as compared to the conventional scalable video coding at higher bitrates. This implies that it is difficult to estimate the original image at the highest resolution only by upsampling the base-layer having the lowest resolution.

As suggested in the present invention, a method of optimally determining whether to estimate from the temporally adjacent frames at the highest resolution or to estimate from the base-layer depends upon whether it provides excellent quality, irrespective of the bitrate.

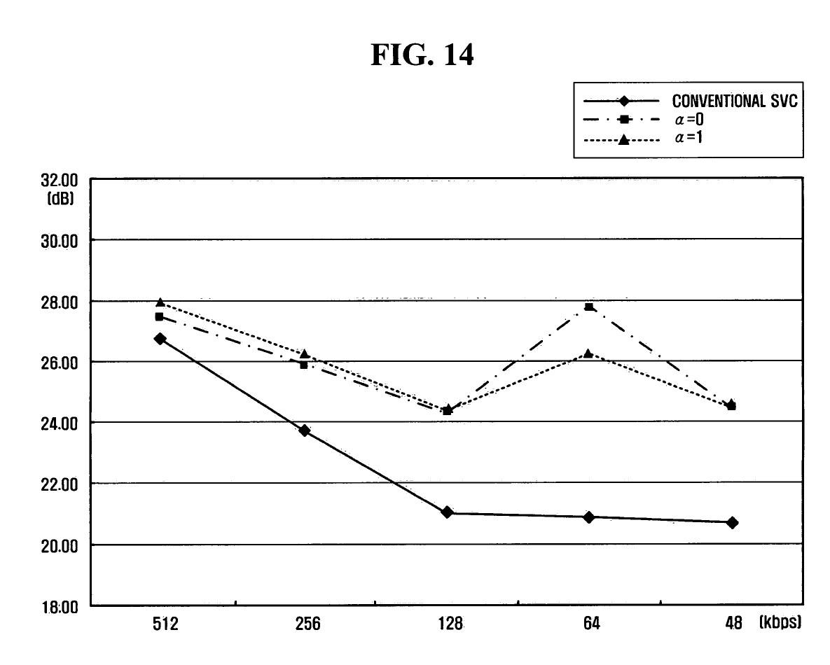

FIG. 14 is a graph comparing PSNRs to bitrates in a “Mobile sequence.” The result of using a method according to exemplary embodiments of the present invention demonstrates that it is similar to the conventional scalable video coding at high bitrates, but it is much better at low bitrates. In particular, when α=1 (mode is selected), a slightly higher performance is achieved at high bitrates but a slightly lower performance is achieved at low bitrates, as compared to when α=0 (only difference coding). However, both show the same performance at the lowest bitrate (48 kbps).

According to exemplary embodiments of the present invention, high performance can be obtained both at low bitrates and high bitrates in the scalable video coding.

According to exemplary embodiments of the present invention, more precise motion estimation can be executed in scalable video coding.

It will be understood by those of ordinary skill in the art that various replacements, modifications and changes in form and details may be made therein without departing from the spirit and scope of the present invention as defined by the following claims. Therefore, it is to be appreciated that the above described exemplary embodiments are for purposes of illustration only and not to be construed as a limitation of the invention.

What is claimed is:

1. A method of efficiently compressing frames at higher layers by use of a base-layer in a multilayer-based video coding method, the method comprising:
generating a base-layer frame from an input original video sequence, having a same temporal position as a first higher layer frame;
upsampling the base-layer frame to have a resolution of another higher layer frame; and
removing redundancy of the first higher layer frame on a block basis by referencing a second higher layer frame having a different temporal position from the first higher layer frame and the upsampled base-layer frame.

2. The method of claim 1, wherein the generating the base-layer frame comprises executing temporal downsampling and spatial downsampling with respect to the input original video sequence.

3. The method of claim 2, wherein the generating the base-layer frame further comprises decoding a result of downsampling after encoding the result with a predetermined codec.

4. The method of claim 2, wherein the spatial downsampling is performed through wavelet transformation.

5. The method of claim 1, wherein the generating the base-layer frame is performed using a coder that represents comparatively better quality to a wavelet-based scalable video codec.

6. The method of claim 1, wherein the removing the redundancy of the first higher layer frame comprises:
computing and coding a difference from the upsampled base-layer frame wherein the another higher layer frame is a low-pass frame; and
coding the second higher layer frame on a block basis, according to one of temporal prediction and base-layer prediction, so that a predetermined cost function is minimized, wherein the another higher layer frame is a high-pass frame.

7. The method of claim 6, wherein the predetermined cost function is computed by Eb+λ×Bb in a case of backward estimation, Ef+λ×Bf in a case of forward estimation, Ebi+λ×Bbi in the case of bi-directional estimation, and α×Ei in a case of estimation using a base-layer, where λ is a Lagrangian coefficient, and Eb, Ef, Ebi and Ei refer to an error of each mode, and Bb, Bf, and Bbi are bits consumed in compressing motion information in each mode, and α is a positive constant.

8. A video encoding method comprising:
generating a base-layer from an input original video sequence;
upsampling the base-layer to have a resolution of a current frame;
performing temporal filtering of each block constituting the current frame by selecting one of temporal prediction and prediction using the upsampled base-layer;
spatially transforming the frame generated by the temporal filtering; and
quantizing a transform coefficient generated by the spatial transformation.

9. The method of claim 8, wherein the generating the base-layer comprises executing temporal downsampling and spatial downsampling with respect to the input original video sequence; and
decoding a result of the downsampling after encoding the result using a predetermined codec.

10. The method of claim 8, wherein the performing the temporal filtering comprises:
computing and coding a difference from the upsampled base-layer where a higher frame among the frames is a low-pass frame; and
coding the higher frame on a block basis using one of the temporal prediction and base-layer prediction so that a predetermined cost function is minimized, where the higher frame is a high-pass frame.

11. A method of restoring a temporally filtered frame with a video decoder, the method comprising:
obtaining a sum of a low-pass frame and a base-layer, where a filtered frame is the low-pass frame; and
restoring a high-pass frame on a block basis according to mode information transmitted from an encoder, wherein the filtered frame is a high-pass frame.

12. The method of claim 11, further comprising restoring the filtered frame by use of a temporally referenced frame wherein the filtered frame is of another temporal level than a highest temporal level.

13. The method of claim 11, wherein the mode information includes at least one of backward estimation, forward estimation, and bi-directional estimation modes, and a B-intra mode.

14. The method of claim 13, wherein the restoring the high-pass frame comprises obtaining a sum of the block and a concerned area of the base-layer, wherein the mode information of the high-pass frame is the B-intra mode; and
restoring an original frame according to motion information of a concerned estimation mode, where the mode information on a block of the high-pass frame is one of the temporal estimation modes.

15. A video decoding method comprising:
decoding an input base-layer using a predetermined codec;
upsampling a resolution of the decoded base-layer;
inversely quantizing texture information of layers other than the base-layer, and outputting a transform coefficient;
inversely transforming the transform coefficient in a spatial domain; and
restoring an original frame from a frame generated as a result of the inverse-transformation, using the upsampled base-layer.

16. The method of claim 15, wherein the restoring the original frame comprises:
obtaining a sum of the block and a concerned area of the base-layer, wherein a frame generated as the result of inverse transformation is a low-pass frame; and
restoring the high-pass frame on a block basis according to mode information transmitted from the encoder side, wherein the frame generated as the result of inverse transformation is a high-pass frame.

17. The method of claim 16, wherein the mode information includes at least one of backward estimation, forward estimation and bi-directional estimation modes, and a B-intra mode.

18. The method of claim 17, wherein the restoring the high-pass frame comprises obtaining a sum of the block and a concerned area of the base-layer, where the mode information of the high-pass frame is a B-intra mode; and
restoring the original frame according to motion information of a concerned estimation mode, where the mode information on a block of the high-pass frame is one of the temporal estimation modes.

19. A video encoder comprising:
a base-layer generation module which generates a base-layer from an input original video source;
a spatial upsampling module which upsamples the base-layer to a resolution of a current frame;
a temporal filtering module which selects one of temporal estimation and estimation using the upsampled base-layer, and temporally filters each block of the current frame;
a spatial transformation module which spatially transforms a frame generated by the temporal filtering; and
a quantization module which quantizes a transform coefficient generated by the spatial transform.

20. The video encoder of claim 19, wherein the base-layer generation module includes:
a downsampling module which conducts temporal downsampling and spatial downsampling of an input original video sequence;
a base-layer encoder which encodes a result of the downsampling using a predetermined codec; and
a base-layer decoder which decodes the encoded result using a same codec as the one used in encoding.

21. The video encoder of claim 19, wherein the temporal filtering module codes the low-pass frame among the frames by computing a difference from the upsampled based layer, and
codes each block of the high-pass frame by minimizing a predetermined cost function, and by using one of the temporal estimation and estimation using the base-layer.

22. A video decoder comprising:
a base-layer decoder which decodes an input base-layer using a predetermined codec;
a spatial upsampling module which upsamples the resolution of the decoded base-layer;
an inverse quantization module which inversely quantizes texture information about layers other than the base-layer, and outputs a transform coefficient;
an inverse spatial transform module which inversely transforms the transform coefficient into a spatial domain; and
an inverse temporal filtering module which restores an original frame from a frame generated as the result of inverse transformation, by use of the upsampled base-layer.

23. The video decoder of claim 22, wherein the inverse temporal filtering module obtains a sum of the block and a concerned area of the base-layer, wherein the frame generated as the result of inverse transformation is a low-pass frame; and
restores the high-pass frame on a block basis according to mode information transmitted from the encoder side, wherein the frame generated as the result of inverse transformation is a high-pass frame.

24. The video decoder of claim 23, wherein the mode information includes at least one of backward estimation, forward estimation and bi-directional estimation modes, and a B-intra mode.

25. The video decoder of claim 24, wherein the inverse temporal filtering module obtains a sum of the block and a concerned region of the base-layer, wherein the mode information of the high-pass frame is a B-intra mode; and
restores the original frame according to motion information of a concerned estimation mode, wherein the mode information of a block of the high-pass frame is one of the temporal estimation modes.

26. A storage medium to record a computer-readable program for executing a method of efficiently compressing frames at higher layers by use of a base-layer in a multilayer-based video coding method, the method comprising:
generating a base-layer frame from an input original video sequence, having a same temporal position as a first higher layer frame;
upsampling the base-layer frame to have a resolution of another higher layer frame; and
removing redundancy of the first higher layer frame on a block basis by referencing a second higher layer frame having a different temporal position from the first higher layer frame and the upsampled base-layer frame.
